(19) United States
(12) Patent Application Publication
(10) Pub. No.: US 2018/0173824 A1
(43) Pub. Date: Jun. 21, 2018

(54) A METHOD AND APPARATUS FOR PERFORMING A MODEL-BASED FAILURE ANALYSIS OF A COMPLEX INDUSTRIAL SYSTEM

(71) Applicant: SIEMENS AKTIENGESELLSCHAFT, MÜNCHEN (DE)

(72) Inventors: GIUSEPPE FABIO CESCHINI, FIRENZE (IT); GULNAR MEHDI, MÜNCHEN (DE); DAVOOD NADERI, FINSPÅNG (SE); MIKHAIL ROSHCHIN, MÜNCHEN (DE)

(21) Appl. No.: 15/579,972

(22) PCT Filed: Jul. 10, 2015
(86) PCT No.: PCT/EP2015/065842

§ 371 Date: Dec. 6, 2017

(30) Foreign Application Priority Data
Jun. 12, 2015 (EP) 15171927.5

(51) Int. Cl. G06F 17/50

(52) U.S. Cl. CPC G06F 17/5009; G06F 2217/02; G06F 2217/06

(57) ABSTRACT

For performing a model-based failure analysis of a complex industrial system including hardware and/or software components each represented by a context independent component model interface terminals and a set of component behavior modes including a normal mode and failure modes of the respective component stated as constraints on deviations, is provided. This method includes generating a system model, SM, of an investigated industrial system by loading component models of the components of said investigated industrial system from a component library and connecting the interface terminals of the loaded component models according to a structure of the investigated industrial system and executing a constraint-based predictive algorithm on a reasoning engine to generate qualitative FMEA results for different operation scenarios, OS, of the investigated industrial system.

### CROSS-REFERENCE TO RELATED APPLICATIONS

This application claims priority to PCT Application No. PCT/EP2015/065842, having a filing date of Jul. 10, 2015, based on European Application No. 15171927.5, having a filing date of Jun. 12, 2015, the entire contents both of which are hereby incorporated by reference.

### FIELD OF TECHNOLOGY

The following relates to a method for performing a model-based failure analysis of a complex industrial system such as a gas turbine system.

### BACKGROUND

A complex industrial system can comprise a plurality of hardware and/or software components. The performance of a complex industrial system depends on operational conditions of the employed components. For reliability assessment, it is important to predict a failure impact of a failure of a component of the system on the functionality of the system in order to assess, whether this can lead to a critical situation if safety or reliability requirements are violated. Further, the prediction of a failure impact can form the basis for measures to minimize or mitigate the failure impact by design correction and/or maintenance of the respective system. Each complex system can have different operating and process requirements and therefore often differs in its specific design. The failure mode and effects analysis, FMEA, can be used to systematically analyze postulated component failures and to identify the resultant effects on system operations. Conventionally, the FMEA analysis is performed and redone for each variant or version of the investigated industrial system and for each revision of a system design. This analysis is often performed by groups of experts being labour- and time-intensive.

### SUMMARY

An aspect relates to providing automatically fault effect associations which can be used for diagnostic tasks such as root cause analysis.

The following provides according to the first aspect of embodiments of the present invention a method for performing a model-based failure analysis of a complex industrial system consisting of hardware and/or software components each represented by a context independent component model comprising interface terminals and a set of component behaviour modes including a normal mode and failure modes of the respective component stated as constraints on deviations, the method comprising the steps of:

generating a system model of an investigated industrial system by loading component models of the components of said investigated industrial system from a component library and connecting the interface terminals of the loaded component models according to a structure of the investigated industrial system, and
executing a constraint-based predictive algorithm on a reasoning engine to generate qualitative FMEA results for different operation scenarios of the investigated industrial system.

In a possible embodiment of the method according to the first aspect of embodiments of the present invention, the constraint-based predicted algorithm iterates over a Cartesian product of predefined operation scenarios and failure modes of each component to determine, whether the failure propagation entails a local or a system level effect capturing a violation of a functionality of the investigated industrial system.

In a further possible embodiment of the method according to the present invention, the interface terminals of a component model are formed by channels to other components comprising interface variables exchanged with the other components of the investigated industrial system.

In a further possible embodiment of the method according to the present invention, the component model of a component comprises state variables indicating a state of said component.

In a further possible embodiment of the method according to the present invention, the component model of a component comprises a base model capturing a physical behaviour of said component.

In a further possible embodiment of the method according to the present invention, the component model comprises deviation models capturing deviations of actual values of variables from reference values of the variables.

In a further possible embodiment of the method according to the present invention, the component model comprises local effects indicating effects of component faults of said component on a functionality of the investigated industrial system.

In a further possible embodiment of the method according to the present invention, the generated FMEA results are used to predict a failure impact of a failure on the functionality of the investigated industrial system.

In a further possible embodiment of the method according to the present invention, the system model is generated by connecting the interface terminals of loaded component models by a model editor according to a predetermined topology of the investigated industrial system.

In a further possible embodiment of the method according to the present invention, the constraint-based predictive algorithm is executed on said reasoning engine offline during design, maintenance and/or repair of the investigated industrial system and/or online during operation of the investigated industrial system.

In a further possible embodiment of the method according to the present invention, at least one component of said investigated industrial system is controlled in response to the generated FMEA results.

The following provides according to the second aspect of the present invention an apparatus for model-based failure analysis of a complex industrial system consisting of hardware and/or software components each represented by a context independent component model comprising interface terminals and a set of component behaviour modes including a normal mode and failure modes of the respective component stated as constraints on deviations, said apparatus comprising:

a generation unit adapted to generate a system model of an investigated industrial system by loading component models of the components of said investigated industrial system from a component library and connecting the interface terminals of the loaded component models according to a structure of the investigated industrial system, and
a reasoning engine adapted to execute a constraint-based predictive algorithm to generate FMEA results for different operation scenarios of the investigated industrial system.

In a possible embodiment of the apparatus according to the present invention, the apparatus further comprises a database storing the component library comprising component models of components and adapted to store the system model of the investigated industrial system generated by said generation unit.

In a further possible embodiment of the apparatus according to the present invention, the apparatus further comprises a control unit adapted to control at least one component of the investigated industrial system in response to the generated FMEA results.

The following provides according to the present invention an industrial system comprising hardware and/or software components and an apparatus for a model-based failure analysis of the complex industrial system consisting of said hardware and/or software components each represented by a context independent component model comprising interface terminals and a set of component behaviour modes including a normal mode and failure modes of the respective component stated as constraints on deviations, said apparatus comprising:

a generation unit adapted to generate a system model of the industrial system by loading component models of the components of the industrial system from a component library and connecting the interface terminals of the loaded component models according to a structure of the industrial system, and
a reasoning engine adapted to execute a constraint-based predictive algorithm to generate FMEA results for different operation scenarios of the industrial system.

### BRIEF DESCRIPTION

Some of the embodiments will be described in detail, with references to the following figures, wherein like designations denote like members, wherein:

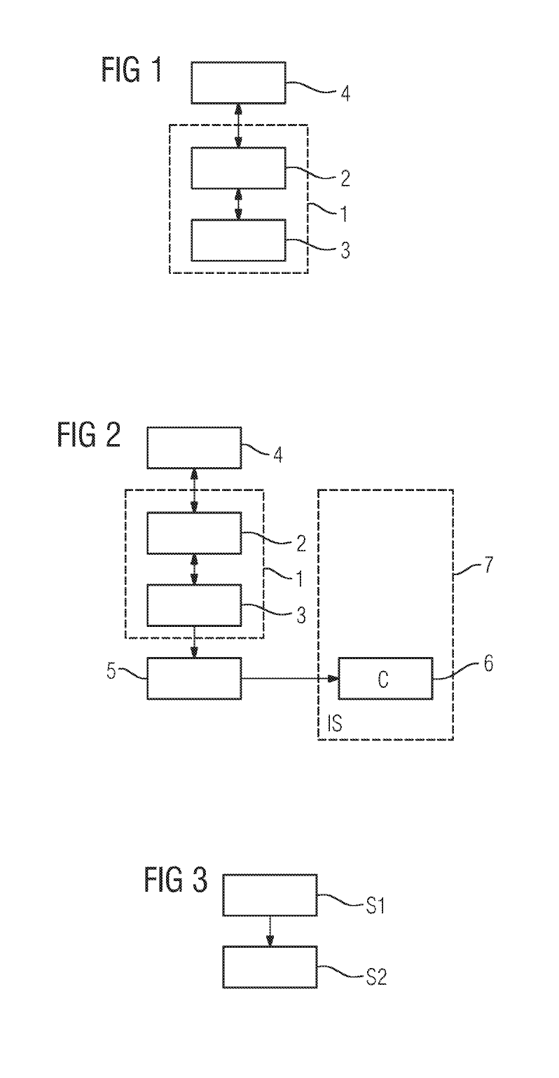

FIG. 1 shows a block diagram of a possible exemplary embodiment of an apparatus according to an aspect of embodiments of the present invention;

FIG. 2 shows a further block diagram for illustrating a further possible embodiment of an apparatus in an industrial system according to a further aspect of embodiments of the present invention;

FIG. 3 shows a flowchart illustrating a possible exemplary embodiment of a method for performing a model-based failure analysis of a complex industrial system according to a further aspect of embodiments of the present invention;

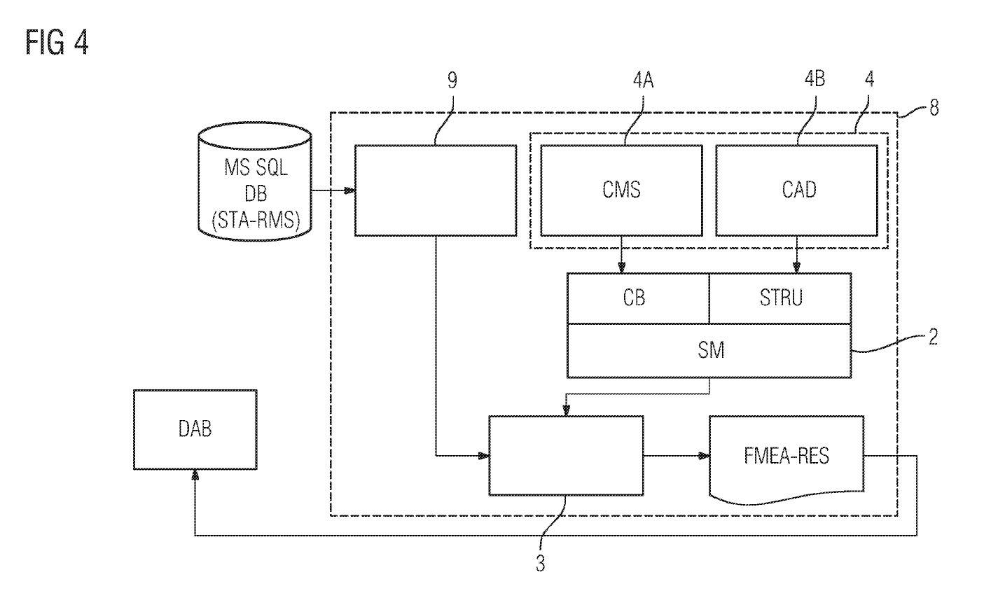

FIG. 4 shows a diagram for illustrating a method and apparatus according to embodiments of the present invention; and

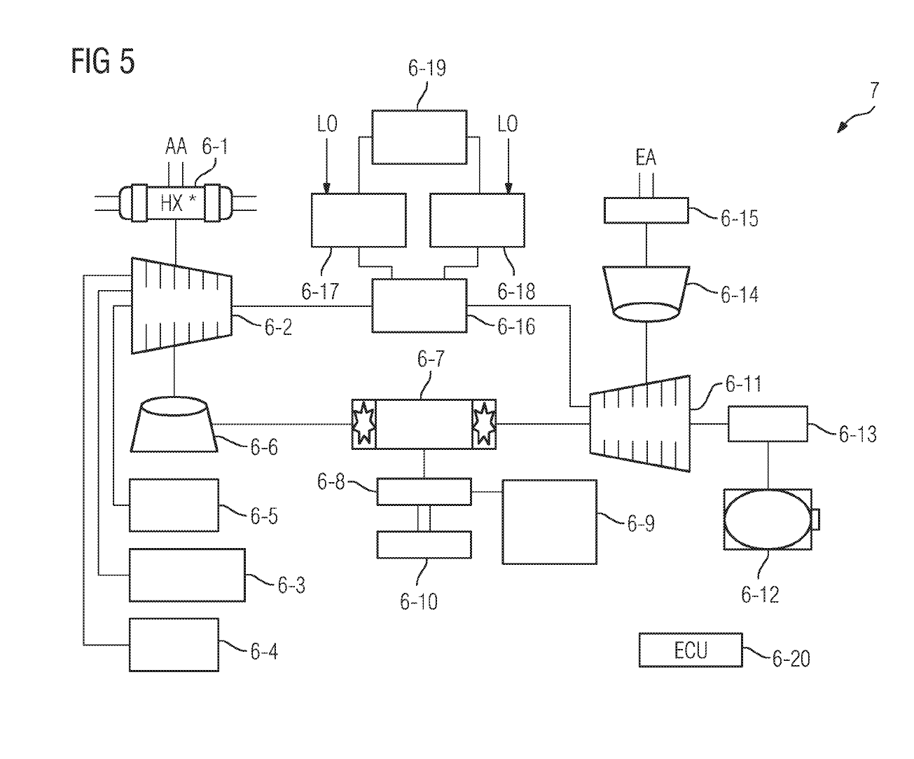

FIG. 5 shows a physical model of an exemplary complex industrial system which can be analyzed by using a method and apparatus according to embodiments of the present invention;

### DETAILED DESCRIPTION

In the shown embodiment of FIG. 1, the apparatus 1 for a model-based failure analysis of a complex industrial system 7 can comprise a generation unit 2 and a reasoning engine 3. The apparatus 1 as illustrated in FIG. 1 is adapted to perform a model-based failure analysis of any kind of complex industrial systems 7 consisting of hardware and/or software components C. Each component or part of the industrial system 7 can be represented by a context independent component model CM comprising interface terminals and a set of a component behaviour modes including a normal mode NM as well as failure modes FM of the respective component C stated as constraints on deviations. In a possible embodiment, the component models CM and the different components can be stored in a database or data memory 4 as illustrated in FIG. 1. The generation unit 2 of the apparatus 1 is adapted to generate a system model SM of an investigated industrial system 7 by loading component models CM of the components of the respective investigated industrial system 7 from a component library and connecting the interface terminals of the loaded component models CM according to a structure of the investigated industrial system 7. In a possible embodiment, the database 4 stores a component library comprising component models CM of different components. The database 4 can be adapted to store the system model SM of the investigated industrial system 7 generated by the generation unit 2. In a possible embodiment, the system model of the investigated industrial system 7 is generated by the generation unit 2 by connecting the interface terminals of loaded component models CM by means of a model editor according to a predetermined topology of the investigated industrial system 7.

The apparatus 1 further comprises a reasoning engine 3 which is adapted to execute a constraint-based predictive algorithm to generate FMEA results for different operation scenarios of the investigated industrial system 7. In a possible embodiment, the generated FMEA results are used to predict a failure impact of a failure of one or several components on the functionality of the investigated industrial system 7. In a possible embodiment, the constraint-based predictive algorithm is executed by the reasoning engine 3 offline during design, maintenance and/or repair of the investigated industrial system 7. In a further possible embodiment, the constraint-based predictive algorithm is executed on the reasoning engine 3 online during operation of the investigated industrial system. The constraint-based predictive algorithm iterates over a Cartesian product of predefined operation scenarios OS and failure modes FM of each component or part to determine whether the failure propagation entails a local and/or system level effect E capturing a violation of a functionality of the investigated industrial system 7.

The database 4 comprises a component library of component models. Each hardware and/or software component is represented by a context independent component model CM comprising interface terminals and a set of component behaviour modes. These behaviour modes include a normal or okay mode and failure modes FM of the respective component. The different modes are stated in a preferred embodiment as constraints on deviations. The interface terminals of the component model are formed by channels to other components comprising interface variables exchanged with the other components of the investigated industrial system. In a possible embodiment, the component model CM of a component stored within the component library can comprise state variables indicating a state of the respective component. The component model further comprises a base model BM capturing a physical behaviour of the respective component. For instance, the base model BM can describe a physical and/or thermodynamic behaviour of the industrial system. In a possible embodiment, the component model CM comprises deviation models DM capturing deviations of actual values of variables from reference values of the respective variables. In a possible embodiment, the component model CM comprises also local effects indicating effects of component faults of the component on a functionality of the investigated industrial system 7.

FIG. 2 shows a block diagram of a further possible embodiment of an apparatus 1 for a model-based failure analysis of a complex industrial system. In the illustrated embodiment, the apparatus 1 comprises a control unit 5 adapted to control at least one component 6 within an investigated industrial system 7 in response to the FMEA results provided by the reasoning engine 3 of the apparatus 1. The component 6 of the complex industrial system 7 can be formed by a hardware or software component of the industrial system 7. The industrial system 7 illustrated in FIG. 2 can be for example an industrial system comprising a rotating component such as a gas turbine engine.

FIG. 3 shows a flowchart of a possible exemplary embodiment of a method for performing a model-based failure analysis of a complex industrial system 7 according to a further aspect of embodiments of the present invention. In a first step S1, a system model SM of the investigated industrial system 7 is generated by loading component models CM of the components 6 of the investigated industrial system 7 from a component library CL and connecting the interface terminals of the loaded component models CM according to a structure STRU of the investigated industrial system 7. In a possible embodiment, the system model SM is generated by connecting the interface terminals of the loaded component models by means of a model editor according to a predetermined topology of the investigated industrial system 7.

In a further step S2, a constraint-based predictive algorithm is executed on a reasoning engine 3 to generate qualitative FMEA results FMEA-RES for different operation OS scenarios of the investigated industrial system 7.

The component model CM of a component 6 defines the behaviour of the component 6 and indicates the interaction of the component 6 with other components 6. The component model CM comprises interface terminals which represent channels to other components. The interface terminals comprise interface variables whose values are influenced by other connected components 6. For example, the interface terminal “output pressure” of one component is received by another component terminal as “input pressure”. For each component 6, one or more interfaces can be defined together with their types to allow exchange of information or data with other components. The interfaces are kept generic to allow changes. The connections are formed by links between two terminals of different components. When connecting terminals their types and variables match each other. In a possible embodiment, the component model CM of a component 6 does comprise interface terminals, state variables and parameters. Further, the component model CM comprises in a possible embodiment at least one base model BM, deviation models DM and local effects E for the respective component 6. A component 6 corresponds to an entity of the investigated industrial system 7. Each component or part can be an elementary component or an aggregation of other components. The component can be represented as classes in a hierarchy where components can inherit properties from parent components or superclasses. In a preferred embodiment, each component 6 is described with general conventions like a relation between a specific design and their direction of rotation. The component model CM comprises a set of component behaviour modes BM including one normal operation mode or okay mode NM and several possible failure modes FM. For example, considering an engine, the failure modes FM can comprise a higher torque and a lower torque of the engine. Further, the component model CM of a component 6 comprises a base model BM which forms the basis for different model variants. The constraint-based predictive algorithm executed in step S2 provides qualitative FMEA results. With the method according to embodiments of the present invention as illustrated in FIG. 3, qualitative results are provided or generated, i.e. a qualitative abstraction to accommodate a partial knowledge about the industrial system 7 and to provide efficient and intuitive representation of its behaviour. These qualitative results are provided for different operation scenarios OS of the investigated industrial system. An operation scenario OS can be formed by a state of the investigated system 7 and also be considered as state of system input which can be selected by a user. For example, if the operation scenario is “operating” and the fault mode is “rotor speed is low”, then a possible result, effect or interference can be “compressor pressure ratio is too low” rather than stating that the pressure ratio has a predetermined value of e.g. 10.0 psi. Accordingly, the FMEA results provided by the method according to embodiments of the present invention are qualitative in nature.

The following table (Table 1) illustrates exemplary FMEA results provided by the method according to embodiments of the present invention for an exemplary industrial system formed by a core turbine engine such as illustrated by the physical model of FIG. 5.

TABLE 1

| Scenario | Part | Failure mode | Local effect | System level effect |
|---|---|---|---|---|
| Turbine_Operating_Nor- | StartupMotor | ElectricDriveFault | »no local effect« | :»no system level effects« |
| malAmbientCondition | | | | |
| Turbine_Operating_Nor- | VGV | Stuck_at_Nega- | reduced_compressor_pres- | :»no svstem level effect« |
| malAmbientCondition | | tiveSwirlAngle | sure_ratio | |
| Turbine_Operating_Nor- | VGV | Stuck_at_Posi- | increase_compressor_pres- | :»no system level effects« |
| malAmbientCondition | | tiveSwirlAngle | sure_ratio | |
| Turbine_Operating_Nor- | BleedValves | Stuck_at_Closed | »no local effect« | :»no system level effects« |
| malAmbientCondition | | | | |
| Turbine_Operating_Nor- | BleedValves | Stuck_at_Open | »no local effect« | :»no system level effects« |
| malAmbientCondition | | | | |
| Turbine_Operating_Nor- | HeatExchanger | LowInletPressure | High_ambient_inlet_temperature | |
| malAmbientCondition | | | | |
| Turbine_Operating_Nor- | HeatExchanger | LowInletPressure | Low_ambient_inlet_pressure | :»no system level effects« |
| malAmbientCondition | | | | |
| Turbine_Operating_Nor- | HeatExchanger | HighInletTem- | High_ambient_inlet_temperature | |
| malAmbientCondition | | perature | | |
| Turbine_Operating_Nor- | HeatExchanger | HighInletTem- | Low_ambient_inlet_pressure | |
| malAmbientCondition | | perature | | |
| Turbine_Operating_Nor- | HeatExchanger | HighInletTem- | | :»no svstem level effects« |
| malAmbientCondition | | perature | | |
| Turbine_Operating_Nor- | Compressor | LowDifferen- | »no local effect« | :Trip_reduced_turbine_pressure |
| malAmbientCondition | | tialPressure | | |
| Turbine_Operating_Nor- | Compressor | LowDifferen- | | :Trip_reduce_turbine_work |
| malAmbientCondition | | tialPressure | | |
| Turbine_Operating_Nor- | Compressor | HighDifferen- | »no local effect« | |
| malAmbientCondition | | tialPressure | | |
| Turbine_Operating_Nor- | Compressor | HighDifferen- | | :Trip_reduce_turbine_work |
| malAmbientCondition | | tialPressure | | |
| Turbine_Operating_Nor- | Compressor | SurgeDetection | »no local effect« | |
| malAmbientCondition | | | | |
| Turbine_Operating_Nor- | Compressor | SurgeDetection | | :Trip_reduced turbine_ressure |
| malAmbientCondition | | | | |
| Turbine_Operating_Nor- | Compressor | SurgeDetection | | :Trip_reduce_turbine_work |
| malAmbientCondition | | | | |
| Turbine_Operating_Nor- | RotorAssembly | UnderSpeed | reduced_compressor_work | :»no system level effects« |
| malAmbientCondition | | | | |
| Turbine_Operating_Nor- | RotorAssembly | OverSpeed | increase_compressor_work | :»no system level effects« |
| malAmbientCondition | | | | |
| Turbine_Operating_Nor- | CompressorDiffuser | Leakage | »no local effect« | :Trip_reduced_turbine_pressure |
| malAmbientCondition | | | | |
| Turbine_Operating_Nor- | CompressorDiffuser | Leakage | | :Trip_reduce_turbine_work |
| malAmbientCondition | | | | |
| Turbine_Operating_Nor- | CombustionChamber | LowPulsation | »no local effect« | |
| malAmbientCondition | | | | |
| Turbine_Operating_Nor- | CombustionChamber | LowPulsation | | :Trip_reduced_turbine_pressure |
| malAmbientCondition | | | | |
| Turbine_Operating_Nor- | CombustionChamber | LowPulsation | | :Trip_reduce_turbine_work |
| malAmbientCondition | | | | |
| Turbine_Operating_Nor- | Combustion-Chamber | LowPulsation | | :Trip_reduced_turbine_temperature |
| malAmbientCondition | | | | |
| Turbine_Operating_Nor- | Combustion-Chamber | HighPulsation | »no local effect« | |
| malAmbientCondition | | | | |
| Turbine_Operating_Nor- | CombustionChamber | HighPulsation | | :Trip_increase_turbine_temperature |
| malAmbientCondition | | | | |
| Turbine_Operating_Nor- | CombustionChamber | HighPulsation | | :Trip_reduced_turbine_pressure |
| malAmbientCondition | | | | |
| Turbine_Operating_Nor- | CombustionChamber | HighPulsation | | :Trip_reduce_turbine_work |
| malAmbientCondition | | | | |
| Turbine_Operating_Nor- | Burner | MainFlameFault | »no local effect« | |
| malAmbientCondition | | | | |
| Turbine_Operating_Nor- | Burner | MainFlameFault | | :Trip_reduced_turbine_temperature |
| malAmbientCondition | | | | |
| Turbine_Operating_Nor- | Burner | PilotFlameFault | »no local effect« | |
| malAmbientCondition | | | | |
| Turbine_Operating_Nor- | Burner | PilotFlameFault | | :Trip_reduced_turbine_temperature |
| malAmbientCondition | | | | |
| Turbine_Operating_Nor- | Burner | Flashback | increase_burner_temperature | |
| malAmbientCondition | | | | |
| Turbine_Operating_Nor- | Burner | Flashback | | :Trip_increase_turbine_temperature |
| malAmbientCondition | | | | |
| Turbine_Operating_Nor- | TurbineSection | LowLoadPer- | reduced_tur- | :»no system level effects« |
| malAmbientCondition | | formance | bine_speed_load_power | |
| Turbine_Operating_Nor- | TurbineSection | HighLoadPer- | increase_tur- | :»no system level effects« |
| malAmbientCondition | | formance | bine_speed_load_power | |
| Turbine_Operating_Nor- | GearBox | LowVibration | »no local effect« | :Trip_low_turbine_load |
| malAmbientCondition | | | | |
| Turbine_Operating_Nor- | GearBox | HighVibration | »no local effect« | :Trip_high_turbine_load |
| malAmbientCondition | | | | |
| Turbine_Operating_Nor- | Generator | Highspeed | High_power | :Trip_high_performance_load |
| malAmbientCondition | | | | |
| Turbine_Operating_Nor- | Generator | LowSpeed | Low_power | :Trip_low_performance_load |
| malAmbientCondition | | | | |
| Turbine_Operating_Nor- | TurbineDiffuser | Leakage | »no local effect« | :Trip_increase_turbine_temperature |
| malAmbientCondition | | | | |
| Turbine_Operating_Nor- | TurbineDiffuser | Leakage | | :Trip_reduced_turbine_pressure |
| malAmbientCondition | | | | |
| Turbine_Operating_Nor- | TurbineDiffuser | Leakage | | :Trip_reduce_turbine_work |
| malAmbientCondition | | | | |
| Turbine_Operating_Nor- | RadialBearings | HighBearingTem- | increase_friction_reduce_speed | |
| malAmbientCondition | | perature | | |
| Turbine_Operating_Nor- | RadialBearings | HighBearingTem- | | :»no system level effects« |
| malAmbientCondition | | perature | | |
| Turbine_Operating_Nor- | RadialBearings | HighVibration | increase_friction_reduce_speed | |
| malAmbientCondition | | | | |
| Turbine_Operating_Nor- | RadialBearings | HighVibration | | :»no system level effects« |
| malAmbientCondition | | | | |
| Turbine_Operating_Nor- | AxialBearings | HighVibration | increase_friction_reduce_speed | |
| malAmbientCondition | | | | |
| Turbine_Operating_Nor- | AxialBearings | HighVibration | | :»no system level effects« |
| malAmbientCondition | | | | |
| Turbine_Operating_Nor- | AxialBearings | AxialDisplacement | increase_friction_reduce_speed | |
| malAmbientCondition | | | | |
| Turbine_Operating_Nor- | AxialBearings | AxialDisplacement | | :»no system level effects« |
| malAmbientCondition | | | | |
| Turbine_Operating_Nor- | AxialBearings | HighBearingTem- | increase_friction_reduce_speed | |
| malAmbientCondition | | perature | | |
| Turbine_Startup_Nor- | StartupMotor | ElectricDriveFault | »no local effect« | :»no system level effects« |
| malAmbientConditions | | | | |
| Turbine_Startup_Nor- | VGV | Stuck_at_Nega- | reduced_compressor_pres- | :»no system level effects« |
| malAmbientConditions | | tive_Swirl_Angle | sure_ratio | |
| Turbine_Startup_Nor- | VGV | Stuck_at_Posi- | increase_compressor_pres- | :»no system level effects« |
| malAmbientConditions | | tive_Swirl_Angle | sure_ratio | |
| Turbine_Startup_Nor- | BleedValves | Stuck_at_Closed | »no local effect« | :»no system level effects« |
| malAmbientConditions | | | | |
| Turbine_Startup_Nor- | BleedValves | Stuck_at_Open | »no local effect« | :»no system level effects« |
| malAmbientConditions | | | | |
| Turbine_Startup_Nor- | HeatExchanger | LowInletPressure | High_ambient_inlet_temperature | |
| malAmbientConditions | | | | |
| Turbine_Startup_Nor- | HeatExchanger | LowInletPressure | Low ambient_inlet_pressure | :»no system level effects« |
| malAmbientConditions | | | | |
| Turbine_Startup_Nor- | HeatExchanger | HighInletTem- | High_ambient_inlet_temperature | |
| malAmbientConditions | | perature | | |
| Turbine_Startup_Nor- | HeatExchanger | HighInletTem- | Low_ambient_inlet_pressure | |
| malAmbientConditions | | perature | | |
| Turbine_Startup_Nor- | HeatExchanger | HighInletTem- | | :»no system level effects« |
| malAmbientConditions | | perature | | |
| Turbine_Startup_Nor- | Compressor | LowDifferen- | »no local effect« | :startup_abort_low_pressure |
| malAmbientConditions | | tialPressure | | |
| Turbine_Startup_Nor- | Compressor | HighDifferen- | »no local effect« | :»no system level effects« |
| malAmbientConditions | | tialPressure | | |
| Turbine_Startup_Nor- | Compressor | SurgeDetection | »no local effect« | |
| malAmbientConditions | | | | |
| Turbine_Startup_Nor- | Compressor | SurgeDetection | | :startup_abort_low_pressure |
| malAmbientConditions | | | | |
| Turbine_Startup_Nor- | RotorAssembly | UnderSpeed | reduced_compressor_work | :»no system level effects« |
| malAmbientConditions | | | | |
| Turbine_Startup_Nor- | RotorAssembly | OverSpeed | increase_compressor_work | :»no system level effects« |
| malAmbientConditions | | | | |
| Turbine_Startup_Nor- | CompressorDiffuser | Leakage | »no local effect« | :startup_abort_low_pressure |
| malAmbientConditions | | | | |
| Turbine_Startup_Nor- | CombustionChamber | LowPulsation | »no local effect« | |
| malAmbientConditions | | | | |
| Turbine_Startup_Nor- | CombustionChamber | LowPulsalion | | :startup_abort_low_pressure |
| malAmbientConditions | | | | |
| Turbine_Startup_Nor- | CombustionChamber | HighPulsation | »no local effect« | |
| malAmbientConditions | | | | |
| Turbine_Startup_Nor- | CombustionChamber | HighPulsation | | :startup_abort_low_pressure |
| malAmbientConditions | | | | |
| Turbine_Startup_Nor- | Burner | MainFlameFault | »no local effect« | :»no system level effects« |
| malAmbientConditions | | | | |
| Turbine_Startup_Nor- | Burner | PilotFlameFault | »no local effect« | :»no system level effects« |
| malAmbientConditions | | | | |
| Turbine_Startup_Nor- | Burner | Flashback | increase_burner_temperature | :»no system level effects« |
| malAmbientConditions | | | | |
| Turbine_Startup_Nor- | TurbineSection | LowLoadPer- | reduced_tur- | :»no system level effects« |
| malAmbientConditions | | formance | bine_speed_load_power | |
| Turbine_Startup_Nor- | TurbineSection | HighLoadPer- | increase_tur- | :»no system level effects« |
| malAmbientConditions | | formance | bine_speed_load_power | |
| Turbine_Startup_Nor- | GearBox | LowVibration | »no local effect« | :Trip_low_turbine_load |
| malAmbientConditions | | | | |
| Turbine_Startup_Nor- | GearBox | HighVibration | »no local effect« | Trip_high_turbine_load |
| malAmbientConditions | | | | |
| Turbine_Startup_Nor- | Generator | Highspeed | High_power | Trip_high_performance_load |
| malAmbientConditions | | | | |
| Turbine_Startup_Nor- | Generator | LowSpeed | Low_power | Trip_low_performance_lead |
| malAmbientConditions | | | | |
| Turbine_Startup_Nor- | TurbineDiffuser | Leakage | »no local effect« | :startup_abort_low_pressure |
| malAmbientConditions | | | | |
| Turbine_Startup_Nor- | RadialBearings | HighBearingTem- | increase_friction_reduce_speed | |
| malAmbientConditions | | perature | | |
| Turbine_Startup_Nor- | RadialBearings | HighBearingTem- | | :»no system level effects« |
| malAmbientConditions | | perature | | |
| Turbine_Startup_Nor- | Radial-Bearings | HighVibration | increase_friction_reduce_speed | |
| malAmbientConditions | | | | |
| Turbine_Startup_Nor- | RadialBearings | HighVibration | | :»no system level effects« |
| malAmbientConditions | | | | |
| Turbine_Startup_Nor- | AxialBearings | HighVibration | increase_friction_reduce_speed | |
| malAmbientConditions | | | | |
| Turbine_Startup_Nor- | AxialBearings | HighVibration | | :»no system level effects« |
| malAmbientConditions | | | | |
| Turbine_Startup_Nor- | AxialBearings | AxialDisplacement | increase_friction_reduce_speed | |
| malAmbientConditions | | | | |
| Turbine_Startup_Nor- | AxialBearings | AxialDisplacement | | :»no system level effects« |
| malAmbientConditions | | | | |
| Turbine_Startup_Nor- | AxialBearings | HighBearingTem- | increase_friction_reduce_speed | |
| malAmbientConditions | | perature | | |
| Turbine_Startup_Nor- | AxialBearings | HighBearingTem- | | :»no system level effects« |
| malAmbientConditions | | perature | | |

The components 6 of the investigated industrial system 7 must comply as much as possible with the physical system. After a component 6 has been identified, a corresponding component model CM can be loaded from the component library CL stored in the database 4. If a component model CM for the respective component 6 does not yet exist, a corresponding component model can be generated by a user or expert and stored in the component library CL. Component models CM are kept in preferred embodiment as generic as possible, i.e. context-free, so that the component model CM can be used for different systems (reusability). For example, the component model of an electric motor can be used in a loop or a system as well as in a core engine system, because its inherent functionality remains the same. The component model CM comprises one or several deviation models DM capturing deviations of actual values of variables from reference values of the respective variables. Qualitative deviation models DM are provided to determine potential failure causes and their effects. In the normal or okay behaviour mode NM of the component 6, the deviation of a variable is zero. In contrast, in a failure mode FM, the deviation is either positive or negative. The deviation can be expressed as Δx=x_{act}−x_{ref}.

If all component models CM of all components 6 of the respective system 7 are available, they can be connected by means of an editor according to the topology of the investigated system 7. This means that one industrial system 7 can be configured or reconfigured using different topologies or structures STRU to provide different system models SM. After a specific system model SM of the investigated system 7 has been specified or selected, operation conditions or operation scenarios OS can be defined as input data. These operation scenarios OS can be stated as qualitative constraints on deviations. After having generated the system model SM in step S1, a constraint-based predictive algorithm can be run for a FMEA task. This constraint-based predictive algorithm is adapted to solve a finite constraint satisfaction problem FCSP which can be defined by a tuple (V,C,R), where:

V is a set of variables V={V1, V2, . . . , Vₙ} of the investigated industrial system with the domain DOM({Vᵢ}). The domain can consist of a finite set of numbers or symbols and the variables of the system can have different domains. The overall domain is defined as a Cartesian product of the specific domains for each variable which defines the space in which the component behaviour can be specified:

DOM({Vᵢ})=DOM(V1)×DOM(V2)× . . . ×DOM(Vₙ).

D is a function which maps the variables Vᵢ to the domain DOM({Vᵢ}).

R is a constraint which defines over a set of variables {Vᵢ} in the domain DOM({Vᵢ}) and characterizes a component, subsystem or system as RDOM({Vᵢ}). A relation R is a constraint and substep of the possible behaviour space. The relation R contains elements which form a tuple. If the relation R is defined on a set of ordered variables, the set can be called a scheme of R and defined as scheme (R). The model fragments mentioned as Rᵢⱼ can be related to a behaviour mode Ei(cⱼ) of the component cⱼ. A mode assignment MA denotes the aggregated system of several modes of components 6 and specifies a unique behaviour mode for each of these components MA={mode Ei(cⱼ)}.

The operation scenarios OS and failure modes FM are represented as a set of constraints or first order formulas. The constraint-based predictive algorithm iterates over the Cartesian product of the operation scenarios OS and failure modes FM and checks, whether they entail the defined failure mode via a constraint solver. It checks whether a given operation scenario OS and failure mode FM entails a local level and/or system level effect E or not. Effects E can also be stated as constraints and capture the violation of certain functionality. The FMEA results can be used to predict the failure impact on the functionality of the investigated system 7 in order to assess, whether they can lead to a critical situation where safety reliability requirements are violated. Further, the FMEA results can be used to minimize or mitigate any negative impact through a design correction of a system or a component design or through maintenance of the investigated system.

FIG. 4 shows a diagram for illustrating an embodiment the method and apparatus according to embodiments of the present invention. An illustrated model-based reasoning framework 8 can comprise a configurator 9 adapted to specify for example a product unit type and to select within a predefined list of operation scenarios OS a specific operation scenario such as “start-up scenario”, “operation with high load” or “operation with low load”, etc. The user can choose to which system level effect the analysis is performed. For example, the user can analyse a loop or a subsystem level effect or a gas turbine system level effect. In a possible embodiment, a customized system model SM of the investigated system 7 can be defined by drag and drop options of a model editor using different configurations of the component models CMS (read from a component library 4A stored in database 4. The component models CMS indicate the component behaviour CB of the respective components 6 within the industrial system 7. The database 4 can comprise a memory 4B for storing CAD data indicating the structure STRU or topology of the investigated industrial system 7. In a possible embodiment, once the system model SM is plugged in, a user can run the constraint-based predicted algorithm and draw FMEA results, for instance in form of a PDF document. The system model editor allows defining terminal types, domain types, component types, etc. The configurator 9 as illustrated in FIG. 4 can be used to define a specific operation scenario OS for analysis. After the operation scenario OS has been defined, the constraint-based predictive algorithm is executed on a reasoning engine 3 to generate the FMEA results FMEA-RES supplied to a Dashboard DAB. The provided FMEA results are inherently qualitative even after parameters have been fixed. For instance, the FMEA results FMEA-RES express “loss of produce pressure” rather than “ . . . of size X” and “turbine coasting down” rather than “ . . . with size Y”.

FIG. 5 shows a physical model of an exemplary industrial system (IS)7 to be investigated. The investigated exemplary industrial system 7 comprises components 6-i. In the illustrated example, the investigated system 7 is a core gas turbine engine. A core gas turbine engine forms the heart of any industrial gas turbine. The purpose of the core gas turbine engine is to generate a flow of pressurized hot gas which is converted into mechanical energy. The mechanical engine can then drive a load such as an electrical generator via a gearbox. The core engine can be divided into three major sections, i.e. a compressor, a combustor and a turbine section. FIG. 5 illustrates the main mechanical, thermodynamical, computerdynamical and software components 6 of the core gas turbine engine 7. The ambient air AA is captured by an air intake system which is cooled down or heated up by a heat exchanger component 6-1. The ambient air AA enters a compressor 6-2 with a specific temperature and with specific pressure. The compressor 6-2 draws air and compresses the air by using an adiabatic thermodynamic process. The compressor section 6-2 can be formed by a fifteen-stage axial-flow compressor. It can comprise variable guided vanes 6-3 that control the pressure ratio by its controlled positioning and angle. Bleed valve 6-4 can also form part of the compressor section which control the surge by its position. The compressor 6-2 in its start-up phase of the turbine is operated by a start-up motor.

The compressed air from the compressor 6-2 enters a diffuser 6-6 which only propagates the airflow to the next component which is formed by the combustor. The air is heated up in the combustion chamber component 6-7. A burner 6-8 and a flame detection system 6-9 form part of the combustor section. The burner component 6-8 is used to mix the gas fuel with the compressed air in the combustion 6-7 and maintains stability of the flame. A gas fuel system 6-10 provides the required fuel to the burner 6-8 and the flame detection system 6-9 monitors the pilot and main flame during a start-up and operation phase.

Finally, the hot gas from the combustion chambers 6-7 enters the turbine 6-11. The turbine component 6-11 expands the air and drives the compressor 6-2 and a generator 6-12. A gearbox 6-13 transmits power from the turbine 6-11 to the generator 6-12. Ultimately, the generator 6-12 is operated to generate electricity for a power grid and the hot gas can be exhausted as exhaust air EA by a diffuser 6-14 to an air exhaust system 6-15.

A rotor assembly 6-16 illustrated in FIG. 5 is a virtual component associated with the rotor shaft speed and considers the rotor welded on the shaft. It can comprise a casing, blades, discs and a axial bearing 6-17 and a radial bearing 6-18. In the illustrated model, only the radial and thrust bearing are considered reducing friction on the rotating shaft. A cooling system 6-19 maintains the temperature of the bearings 6-17, 6-18 receiving also Lube Oil LO.

Based on the sensor values provided by pressure and temperature sensors, an electronic control unit can generate commands to control the mechanical components of the investigated industrial system 7. The mechanical components can be controlled by specialized electronic control units ECUs 6-20. With the method and apparatus according to embodiments of the present invention, it is possible to perform a model-based failure analysis of a complex industrial system 7 such as the core gas turbine engine illustrated in FIG. 5. With the method and apparatus according to embodiments of the present invention, it is possible to identify possible faulty components 6-i that can lead to trips of the turbine, with the objective to reduce these risks by redesigning the existing components or adding other components or in some cases by adding additional sensor devices. The components can exchange variables which represent physical quantities through interfaces. The physical quantities exchanged between the components 6-i can for instance comprise a temperature, a pressure, a flowrate, a position, a speed or active power as well as signals and/or commands, etc. The deviations of these quantities from nominal values can be expressed as Δ“Physical Quantity”, e.g. for the physical quantity pressure it would be ΔP. The purpose of such an analysis can be for example, whether the pressure ratio in the compressor is sufficient and/or whether the temperature in the combustor is nominal and/or whether the rotor speed is up to a setting point and/or the power output of the turbine can synchronize with the generator.

Table 1 illustrates the model-based generation of FMEA results for the core turbine engine. The start-up operation scenario happens when the motor is commanded to start to drive the compressor, air from inlet system is captured, valves take up their positions and rotation begins. During the start-up operation scenario, the motor, VGV, bleed valves positions are important and can affect the turbine and compressor. The operation scenario is reached when the turbine produces active power, the main flame is on and the rotor attains its maximum speed.

For the exemplary use case illustrated in FIG. 5, different domains can be defined as follows:

TABLE 2

| Domain Name | Element Values | Description |
|---|---|---|
| Sign | {−, 0, +} | Sign for real number |
| | | or integers |
| Boolean | {F, T} | F = False |
| | | T = True |
| String | {startup, standstill, | |
| | operation, coastdown, stop, | |
| | on, off} | |

Domain, Terminals, Constants

| Domain Name | Element Values | Description |
|---|---|---|
| Sign | {−, 0, +} | Sign for real number |
| | | or integers |
| Boolean | {F, T} | F = False |
| | | T = True |
| GTCommandString | {startup, standstill, | |
| | operation, coastdown, stop, | |
| | on, off} | |
| PosSign | 0, +, ++ | |
| CombustorString | Main, Pilot, Central | |

Further, it is possible to define different terminals as illustrated in the following Tables 3 and 4:

TABLE 3

| | | Operation ort | | |
|---|---|---|---|---|
| Terminal Type | Variables | Terminal | Domain | Description |
| Temperature | T | Equal | Sign | Temperature from one side of the component |
| | ΔT | Equal | Sign | Deviation of temperature coming from one side of the |
| | | | | component |
| Pressure | P | Equal | Sign | Pressure from one side of the component |
| | ΔP | Equal | Sign | Deviation of pressure coming from one side of the component |
| Command | cmd | Equal | Boolean | Command send from the CPU to control components. T = |
| | | | | Activate/Engage, F = do not Activate/Engage |
| | Δcmd | Equal | Boolean | Deviation means whether the command is sent wrongly or not, |
| | | | | T = the command is correct, F = it is not |
| AuxiliaryTerminal | T | Equal | Sign | Temperature from one side of the component |
| | P | Equal | Sign | Pressure from one side of the component |
| | F | Equal | Sign | Flowrate from one side of the component |
| GTCommand | Cmd | Equal | String | Command from GT system on the state of the operation |
| | | | | {{startup, standstill, operation, coastdown, stop} |

| Terminal Type | Variables | Domain | Description |
|---|---|---|---|
| Command | cmd | Boolean | Command send from the CPU to control components. T = |
| | | | Activate, F = do not Activate |
| | Δcmd | Boolean | Deviation means whether the command is sent wrongly or not, T = |
| | | | the command is correct, F = it is not |
| GTCommand | cmd | GTCommandString | Command from GT system on the state of the operation {{startup, |
| | | | standstill, operation, coastdown, stop} |
| | Δcmd | Boolean | |
| CommandPosition | Cmd | PosSign | |
| | Δcmd | Boolean | |
| SpeedMotorTerminal | A | Sign | Active power |
| | V | Sign | speed |
| | Δa | Sign | Deviation in Active power |
| GasFlowPathTerminal | T | Sign | Temperature |
| | P | Sign | Pressure |
| | F | Sign | Flowrate |
| | ΔT | Sign | Deviation Temperature from one side of the component |
| | ΔP | Sign | Deviation Pressure from one side of the component |
| | ΔF | Sign | Deviation Flowrate from one side of the component |
| Load | v | Sign | Speed |
| | Δv | Sign | Deviation of Speed |
| | Fc | Sign | force |
| | ΔFc | Sign | Deviation force |

TABLE 4

| Terminal Type | Domain Type |
|---|---|
| Temperature | Sign |
| Pressure | Sign |
| Signal | Boolean, |
| | ECU_states |

For the different components, models can be defined in a specific embodiment as follows (Table 5):

TABLE 5

| COMPONENT VIEW | TERMINALS |
|---|---|
| Pictogram with | AT fromGT Auxiliary Terminal Connection |
| Terminals: | GTCommand Command with the Oil Tank to |
| AT_fromGT | the Auxiliary ECU |
| GTCommand | STATE VARIABLES |
| | GT_state {startup, standstifl, operation, coastdown, stop} |
| | PARAMETERS |
| | <empty> |

FUNCTION
GT system is a virtual component for now that specifies the state of operation of the Gas
Turbine System and drainage the oil from its bearing back to the Oil Tank reservoir.
The GT system will change when we model for gas turbine subsystem - MBA.
Assumption: No failure modes for now.

| | |
|---|---|
| Base Model | Background Model: |
| | [Auxiliary Balance] |
| | GTSystemState(GT_state, AT_fromGT.T, AT_fromGT.P, |
| | AT_fromGT.F); |
| | [Signal Balance] |
| | Equal(GT_state, GTCommand.cmd); |
| | OK Model: |
| | <empty> |
| Deviation | Background Model: |
| Models | <empty> |
| | OK Model: |
| | [Auxiliary Balance] |
| | Equal(AT_fromEngine.ΔT, 0); |
| | Equal(AT_fromEngine.ΔP, 0); |
| | Equal(AT_fromEngine.ΔF, 0); |
| | Fault Modes: |
| | <empty> |
| Local Effect | |

VariableGuidedVanes

| COMPONENT VIEW | TERMINALS |
|---|---|
| | F_fromVGV Flow. Terminal |
| | Connection with compressor |
| | Command GTCommand |
| | Connection with ECU |
| | STATE VARIABLES |
| | Boolean pos |
| | PARAMETERS |
| | <empty> |

FUNCTION

| | |
|---|---|
| Base Model | Background Model: |
| | VGVAngleConstraint(pos, F_fromVGV.F); |
| | OK Model: |
| | Equal(pos, Command.cmd); |
| Deviation Models | Background Model: |
| | <empty> |
| | OK Model: |
| | OK Model: |
| | Equal(Δpos, Command. Δcmd); |
| | Fault Modes: |
| | Stuck_at_NegativeSwirl: |
| | Add(Command. Δcmd, +, Δpos); |
| | Equal (F_fromVGV.ΔF, −); |
| | Stuck_at_PositiveSwirl: |
| | Add(Command. Δcmd, −, Δpos); |
| | Equal(F_fromVGV.ΔF, +); |
| Local Effect | increase_compressor_pressure_ratio |
| | Δpos,F_fromVGV.ΔF; |
| | T, +; |
| | reduced_compressor_pressure_ratio |
| | Δpos,F_fromVGV.ΔF; |
| | F, −; |

Heat Exchanger

| COMPONENT VIEW | TERMINALS |
|---|---|
| | Flow_fromAmbient Flow. Terminal |
| | Connection with ambient conditions |
| | Gasflow_fromHX GasFlowPath. Terminal |
| | Connection with Compressor |
| | Command Command |
| | Connection with ECU |
| | STATE VARIABLES |
| | Sign CoolantFlow |
| | Sign CoolantPressure |
| | Sign CoolantTemperature |
| | PARAMETERS |
| | <empty> |

FUNCTION

| | |
|---|---|
| Base Model | Background Model: |
| | HeatExchangerCoolantConstraint(Command.cmd, CoolantPressure, |
| | CoolantTemperature, CoolantFlow); |
| | OK Model: |
| Deviation | Background Model: |
| Models | OK Model: |
| | HeatExchangerHeatFlowConstraint(CoolantTemperature, CoolantFlow, |
| | Flow_fromAmbient.T, Flow_fromAmbient.F, |
| | Gasflow_fromHX.T, Gasflow_fromHX.F, Gasflow_fromHX.ΔT); |
| | HeatExchangerPressureConstraint(Flow_fromAmbient.T, Flow_fromAmbient.P, |
| | Gasflow_fromHX.P, Gasflow_fromHX.ΔP); |
| | Fault Modes: |
| | HighInletTemperature: |
| | Equal(Gasflow_fromHX.ΔT, +); |
| | Equal(Gasflow_fromHX.T, +); |
| | LowInletPressure: |
| | Equal(Gasflow_fromHX.ΔP, −); |
| | Equal(Gasflow_fromHX.P, +); |
| Local Effect | |

These constraints can comprise the constraints listed in the following Table 6:

### Constraints

TABLE 6

| Constraints | Truth Table | | | | | | |
|---|---|---|---|---|---|---|---|
| GTState | //resulting auxiliary in the terminal according to the GT | | | | | | |
| | state | | | | | | |
| | String GT_state, Sign T_fromEng, Sign P_from Eng, Sign | | | | | | |
| | F_from Eng; | | | | | | |
| | startup | −, | −, | −; | | | |
| | standstill | +, | +, | +; | | | |
| | operation | +, | +, | +; | | | |
| | coastdown | +, | +, | +; | | | |
| | stop | 0, | 0, | 0; | | | |
| HeaterState | String heater_state, Sign T_fromheater | | | | | | |
| | T | +; | | | | | |
| | F | 0; | | | | | |
| HeaterOverHeatingConstraint | String heater_state, Sign deltaT_fromheater | | | | | | |
| | T | +; | | | | | |
| | F | 0; | | | | | |
| HeaterLowHeatingConstraint | String heater_state, Sign deltaT_fromheater | | | | | | |
| | T | −; | | | | | |
| | F | 0; | | | | | |
| FanHighPressureConstraint | String fan_state, Sign deltaP_fromfan | | | | | | |
| | T | +; | | | | | |
| | F | 0; | | | | | |
| FanLowPressureConstraint | String fan_state, Sign deltaP_fromfan | | | | | | |
| | T | −; | | | | | |
| | F | 0; | | | | | |
| ECUHeaterConstraint | String GTCommand, Sign deltaT_from-tisa, String | | | | | | |
| | C_toheater | | | | | | |
| | Startup | T, | T; | | | | |
| | Startup | F, | F; | | | | |
| | Standstill | T, | T; | | | | |
| | Standstill | F, | F; | | | | |
| | Operation | T, | T; | | | | |
| | Operation | F, | F; | | | | |
| | Coastdown | *, | F; | | | | |
| | Stop | *, | F; | | | | |
| ECUHeaterConstraint | String GTCommand, Sign deltaP_from-pisa, String | | | | | | |
| | C_tofan | | | | | | |
| | Startup | T, | T; | | | | |
| | Startup | F, | F; | | | | |
| | Standstill | T, | T; | | | | |
| | Standstill | F, | F; | | | | |
| | Operation | T, | T; | | | | |
| | Operation | F, | F; | | | | |
| | Coastdown | *, | F; | | | | |
| | Stop | *, | F; | | | | |
| AuxiliaryPropagation | Boolean pos, Sign aux1, Sign aux2, Sign flow; | | | | | | |
| | F, | *, | *, | 0; | | | |
| | T, | 0, | 0, | 0; | | | |
| | T, | +, | +, | *; | | | |
| | T, | +, | 0, | +; | | | |
| | T, | 0, | +, | −; | | | |
| AuxiliaryPropagation2 | Boolean pos, Sign aux1, Sign aux2; | | | | | | |
| | T, | *, | 0; | | | | |
| | F, | 0, | 0; | | | | |
| | F, | +, | +; | | | | |
| | F, | −, | −; | | | | |
| CheckValveConstraint | PosSign pos, Sign Aux1, Sign Aux2, Sign Aux3, Sign AuxPump, | | | | | | |
| | Sign AuxCooler; | | | | | | |
| | +, | 0, | 0, | 0, | 0, | 0; | |
| | +, | 0, | 0, | +, | +, | +; | |
| | +, | 0, | +, | 0, | +, | +; | |
| | +, | 0, | +, | +, | +, | +; | |
| | +, | +, | 0, | 0, | +, | +; | |
| | +, | +, | 0, | +, | +, | +; | |
| | +, | +, | +, | 0, | +, | +; | |
| | +, | +, | +, | +, | +, | +; | |
| | ++, | 0, | 0, | 0, | 0, | 0; | |
| | ++, | 0, | 0, | +, | +, | 0; | |
| | ++, | 0, | +, | 0, | +, | 0; | |
| | ++, | 0, | +, | +, | +, | 0; | |
| | ++, | +, | 0, | 0, | +, | 0; | |
| | ++, | +, | 0, | +, | +, | 0; | |
| | ++, | +, | +, | 0, | +, | 0; | |
| | ++, | +, | +, | +, | +, | 0; | |
| | 0, | 0, | 0, | 0, | 0, | 0; | |
| | 0, | 0, | 0, | +, | 0, | +; | |
| | 0, | 0, | +, | 0, | 0, | +; | |
| | 0, | 0, | +, | +, | 0, | +; | |
| | 0, | +, | 0, | 0, | 0, | +; | |
| | 0, | +, | 0, | +, | 0, | +; | |
| | 0, | +, | +, | 0, | 0, | +; | |
| | 0, | +, | +, | +, | 0, | +; | |
| | +, | 0, | 0, | 0, | 0, | 0; | |
| | +, | 0, | 0, | −, | −, | −; | |
| | +, | 0, | −, | −, | −, | −; | |
| | +, | 0, | −, | 0, | −, | −; | |
| | +, | −, | 0, | 0, | −, | −; | |
| | +, | −, | 0, | −, | −, | −; | |
| | +, | −, | −, | 0, | −, | −; | |
| | +, | −, | −, | −, | −, | −; | |
| | ++, | 0, | 0, | 0, | 0, | 0; | |
| | ++, | 0, | 0, | −, | −, | 0; | |
| | ++, | 0, | −, | 0, | −, | 0; | |
| | ++, | 0, | −, | −, | −, | 0; | |
| | ++, | −, | 0, | 0, | −, | 0; | |
| | ++, | −, | 0, | −, | −, | 0; | |
| | ++, | −, | −, | 0, | −, | 0; | |
| | ++, | −, | −, | −, | −, | 0; | |
| | 0, | 0, | 0, | 0, | 0, | 0; | |
| | 0, | 0, | 0, | −, | 0, | −; | |
| | 0, | 0, | −, | 0, | 0, | −; | |
| | 0, | 0, | −, | −, | 0, | −; | |
| | 0, | −, | 0, | 0, | 0, | −; | |
| | 0, | −, | 0, | −, | 0, | −; | |
| | 0, | −, | −, | 0, | 0, | −; | |
| | 0, | −, | −, | −, | 0, | −; | |
| CoolerConstraint | Sign Aux_fromTank, Sign Aux_fromCooler; | | | | | | |
| | +, | −; | | | | | |
| | −, | −; | | | | | |
| | 0, | 0; | | | | | |
| deltaCmdConstraint | // cmd = F means not engaged, T means engaged signal | | | | | | |
| | //delta cmd = F means no error, T means error, of the command | | | | | | |
| | //Eng = F means not engaged, T engange, physically | | | | | | |
| | //delta Eng = F means no error, T means error of the physical | | | | | | |
| | condition | | | | | | |
| | Boolean cmd, Boolean Δcmd, Boolean pos, Boolean Δpos; | | | | | | |
| | F, | F, | F, | F; | | | |
| | F, | T, | F, | T; | | | |
| | F, | F, | T, | T; | | | |
| | F, | T, | T, | F; | | | |
| | T, | F, | F, | T; | | | |
| | T, | T, | F, | F; | | | |
| | T, | F, | T, | F; | | | |
| | T, | T, | T, | T; | | | |
| DeltaFlowConstraint | Sign FlowfromTank, Sign deltaFlow-fromTank; | | | | | | |
| | 0, | *; | | | | | |
| | +, | 0; | | | | | |
| | −, | −; | | | | | |
| FanState | Boolean Fan_state, Sign deltaP_from-Fan; | | | | | | |
| | F, | 0; | | | | | |
| | T, | +; | | | | | |
| GasFuelECUConstraint | GTCommandString GTDemand, Boolean Control1, Boolean | | | | | | |
| | Control2, Boolean Control3, Boolean Isolation, Boolean Shutoff, | | | | | | |
| | Boolean Ventilation; | | | | | | |
| | Startup, | F, | F, | T, | T, | T, | F; |
| | Standstill, | F, | T, | F, | T, | T, | F; |
| | Operating, | T, | T, | F, | T, | T, | F; |
| | Coastdown, | T, | T, | F, | T, | T, | F; |
| | Stopping, | F, | F, | F, | T, | F, | T; |
| HeaterState | Boolean Heater_state, Sign T_fromHeater; | | | | | | |
| | F, | 0; | | | | | |
| | T, | +; | | | | | |
| LubeOilECUFanConstraint | GTCommandString GTcmd, Boolean cmdFan; | | | | | | |
| | Startup, | T; | | | | | |
| | Standstill, | T; | | | | | |
| | Operating, | T; | | | | | |
| | Coastdown, | F; | | | | | |
| | Stopping, | F; | | | | | |
| LubeOilECUHeaterConstraint | GTCommandString GTcmd, Boolean cmdHeater; | | | | | | |
| | Startup, | T; | | | | | |
| | Standstill, | T; | | | | | |
| | Operating, | T; | | | | | |
| | Coastdown, | F; | | | | | |
| | Stopping, | F; | | | | | |
| LubeOilECUMotor1Constraint | GTCommandString GTcmd, Boolean cmdM1; | | | | | | |
| | Startup, | T; | | | | | |
| | Standstill, | T; | | | | | |
| | Operating, | T; | | | | | |
| | Coastdown, | F; | | | | | |
| | Stopping, | F; | | | | | |
| LubeOilECUMotor2Constraint | GTCommandString GTcmd, Boolean cmdM2; | | | | | | |
| | Startup, | F; | | | | | |
| | Standstill, | F; | | | | | |
| | Operating, | T; | | | | | |
| | Coastdown, | F; | | | | | |
| | Stopping, | F; | | | | | |
| LubeOilECUMotor3Constraint | GTCommandString GTcmd, Boolean cmdM3; | | | | | | |
| | Startup, | T; | | | | | |
| | Standstill, | F; | | | | | |
| | Operating, | T; | | | | | |
| | Coastdown, | F; | | | | | |
| | Stopping, | F; | | | | | |
| LubeOilECUTempValveConstraint | GTCommandString GTcmd, PosSign cmdTCV; | | | | | | |
| | Startup, | +; | | | | | |
| | Standstill, | +; | | | | | |
| | Operating, | +; | | | | | |
| | Coastdown, | 0; | | | | | |
| | Stopping, | 0; | | | | | |
| PumpPressureConstraint | Sign Speed, Sign P_Totank, Sign P_fromPump; | | | | | | |
| | +, | +, | +; | | | | |
| | +, | −, | +; | | | | |
| | +, | 0, | −; | | | | |
| | 0, | *, | 0; | | | | |
| TemperatureControlValveConstraint | PosSign pos, Sign Aux_fromCooler, Sign Aux_fromTank, Sign | | | | | | |
| | Aux_toFilter; | | | | | | |
| | +, | +, | +, | +; | | | |
| | +, | −, | +, | +; | | | |
| | +, | +, | −, | +; | | | |
| | +, | −, | −, | −; | | | |
| | +, | 0, | +, | +; | | | |
| | +, | 0, | −, | −; | | | |
| | +, | 0, | 0, | 0; | | | |
| | +, | +, | 0, | +; | | | |
| | +, | −, | 0, | −; | | | |
| TemperatureControlValveConstraint2 | PosSign pos, Sign delta_fromCooler, Sign delta_fromTank, Sign | | | | | | |
| | delta_toFilter; | | | | | | |
| | +, | +, | +, | +; | | | |
| | +, | −, | +, | 0; | | | |
| | +, | +, | −, | 0; | | | |
| | +, | −, | −, | −; | | | |
| | +, | 0, | +, | +; | | | |
| | +, | 0, | −, | −; | | | |
| | +, | 0, | 0, | 0; | | | |
| | +, | +, | 0, | +; | | | |
| | +, | −, | 0, | −; | | | |
| ValveDeltaAux | Boolean pos, Boolean Δpos, Sign fromSupplyT, Sign toValΔT; | | | | | | |
| | F, | F, | *, | 0; | | | |
| | F, | T, | −, | −; | | | |
| | F, | T, | 0, | 0; | | | |
| | F, | T, | +, | +; | | | |
| | T, | F, | *, | *; | | | |
| | T, | T, | −, | +; | | | |
| | T, | T, | 0, | 0; | | | |
| | T, | T, | +, | −; | | | |
| ValveDeltaAux2 | Boolean pos, Boolean Δpos, Sign fromSupplyT, Sign toValΔT; | | | | | | |
| | T, | F, | *, | 0; | | | |
| | T, | T, | −, | −; | | | |
| | T, | T, | 0, | 0; | | | |
| | T, | T, | +, | +; | | | |
| | F, | F, | *, | *; | | | |
| | F, | T, | −, | +; | | | |
| | F, | T, | 0, | 0; | | | |
| | F, | T, | + | −; | | | |
| ValveDeltaAuxPropagation | Boolean pos, Boolean Δpos, Sign fromsupplyΔT, Sign | | | | | | |
| | toValveΔT; | | | | | | |
| | T, | F, | −, | −; | | | |
| | T, | F, | 0, | 0; | | | |
| | T, | F, | +, | +; | | | |
| | T, | T, | *, | *; | | | |
| | F, | F, | *, | *; | | | |
| | F, | T, | *, | *; | | | |
| ValveDeltaAuxPropagation2 | Boolean pos, Boolean Δpos, Sign fromsupplyΔT, Sign | | | | | | |
| | toValveΔT; | | | | | | |
| | F, | F, | −, | −; | | | |
| | F, | F, | 0, | 0; | | | |
| | F, | F, | +, | +; | | | |
| | F, | T, | *, | *; | | | |
| | T, | F, | *, | *; | | | |
| | T, | T, | *, | *; | | | |
| BearingsTemperatureConstraint | Sign T_fromCoolingSytem, Sign T_fromLubeOil, Sign | | | | | | |
| | T_fromBearing; | | | | | | |
| | −, | +, | +; | | | | |
| | +, | −, | +; | | | | |
| | −, | −, | −; | | | | |
| | +, | +, | +; | | | | |
| BurnerFlameConstraint | GTCommandString cmd, Boolean main, Boolean pilot; | | | | | | |
| | Startup, | F, | T; | | | | |
| | Standstill, | F, | T; | | | | |
| | Operating, | T, | F; | | | | |
| | Coastdown, | F, | F; | | | | |
| | Stopping, | F, | F; | | | | |
| BurnerTemperatureConstraint | Boolean main, Boolean pilot, Sign TfromGasFuel, Sign | | | | | | |
| | TfromBurner; | | | | | | |
| | F, | F, | *, | 0; | | | |
| | F, | T, | +, | +; | | | |
| | F, | T, | −, | −; | | | |
| | F, | T, | 0, | 0; | | | |
| | T, | F, | +, | +; | | | |
| | T, | F, | −, | −; | | | |
| | T, | F, | 0, | 0; | | | |
| CompressorActiveConstraint | Sign Active, Sign AfromMotor, Sign AfromTurbine; | | | | | | |
| | +, | +, | 0; | | | | |
| | +, | +, | −; | | | | |
| | +, | +, | +; | | | | |
| | +, | 0, | +; | | | | |
| | +, | −, | +; | | | | |
| | +, | 0, | +; | | | | |
| | −, | −, | −; | | | | |
| | 0, | 0, | 0; | | | | |
| EngineCommandBleedValveConstraint | GTCommandString cmd, Boolean cmd; | | | | | | |
| | Startup, | T; | | | | | |
| | Standstill, | T; | | | | | |
| | Operating, | T; | | | | | |
| | Coastdown, | F; | | | | | |
| | Stopping, | F; | | | | | |
| EngineCommandHXConstraint | GTCommandString cmd, Sign deltaT, Sign deltaP, Sign deltaF, | | | | | | |
| | Boolean HXcmd; | | | | | | |
| | Startup, | 0, | 0, | 0, | T; | | |
| | Startup, | +, | 0, | 0, | F; | | |
| | Startup, | −, | 0, | 0, | T; | | |
| | Standstill, | 0, | 0, | 0, | T; | | |
| | Standstill, | +, | 0, | 0, | F; | | |
| | Standstill, | −, | 0, | 0, | T; | | |
| | Operating, | 0, | 0, | 0, | T; | | |
| | Operating, | +, | 0, | 0, | F; | | |
| | Operating, | −, | 0, | 0, | T; | | |
| | Coastdown, | 0, | 0, | 0, | T; | | |
| | Coastdown, | +, | 0, | 0, | F; | | |
| | Coastdown, | −, | 0, | 0, | T; | | |
| | Stopping, | 0, | 0, | 0, | T; | | |
| | Stopping, | +, | 0, | 0, | F; | | |
| | Stopping, | −, | 0, | 0, | T; | | |
| EngineCommandMotorConstraint | GTCommandString cmd, Boolean startupmotor; | | | | | | |
| | Startup, | T; | | | | | |
| | Standstill, | T; | | | | | |
| | Operating, | F; | | | | | |
| | Coastdown, | F; | | | | | |
| | Stopping, | F; | | | | | |
| EngineCommandVGVConstraint | GTCommandString cmd, Boolean cmd; | | | | | | |
| | Startup, | T; | | | | | |
| | Standstill, | T; | | | | | |
| | Operating, | T; | | | | | |
| | Coastdown, | F; | | | | | |
| | Stopping, | F; | | | | | |
| HeatExchangerCoolantConstraint | Boolean Command, Sign Pressure, Sign Temperature, Sign Flow; | | | | | | |
| | T, | +, | +, | +; | | | |
| | F, | +, | −, | +; | | | |
| HeatExchangerHeatFlowConstraint | Sign CoolantTemperature, Sign CoolantFlow, Sign | | | | | | |
| | T_fromAmbient, Sign F_fromAmbient, Sign T_fromHX, Sign | | | | | | |
| | F_fromHX, Sign deltaT_fromHX; | | | | | | |
| | +, | +, | +, | +, | +, | +, | +; |
| | −, | +, | +, | +, | +, | +, | 0; |
| | −, | +, | −, | +, | −, | +, | −; |
| | +, | +, | −, | +, | +, | +, | 0; |
| HeatExchangerPressureConstraint | Sign T_fromAmbient, Sign P_fromAmbient, Sign | | | | | | |
| | P_Gasflow_fromHX, Sign deltaP_Gasflow_fromHX; | | | | | | |
| | +, | +, | +, | 0; | | | |
| | −, | +, | +, | −; | | | |
| RotorAssemblySpeedConstraint | Sign deltaTfromAxial, Sign deltaTfromRadial, Sign | | | | | | |
| | deltaTfromInlet, Sign SpeedfromRotor; | | | | | | |
| | 0, | 0, | 0, | +; | | | |
| | 0, | 0, | +, | +; | | | |
| | 0, | +, | 0, | +; | | | |
| | 0, | +, | +, | +; | | | |
| | +, | 0, | 0, | −; | | | |
| | +, | 0, | +, | −; | | | |
| | +, | +, | 0, | −; | | | |
| | +, | +, | +, | −; | | | |
| | 0, | 0, | −, | +; | | | |
| | 0, | −, | 0, | +; | | | |
| | 0, | −, | −, | −; | | | |
| | −, | 0, | 0, | 0; | | | |
| | −, | 0, | −, | 0; | | | |
| | −, | −, | 0, | 0; | | | |
| | −, | −, | −, | 0; | | | |
| | +, | 0, | −, | +; | | | |
| | 0, | +, | −, | +; | | | |
| VGVAngleConstraint | Boolean Position, Sign F_fromVGV; | | | | | | |
| | T, | +; | | | | | |
| | F, | −; | | | | | |
| GTSystemState | GT CommandString GT, Sign T, Sign P, Sign F; | | | | | | |
| | Startup, | +, | +, | +; | | | |
| | Operating, | +, | +, | +; | | | |
| | Coastdown, | 0, | 0, | 0; | | | |
| | Stopping, | 0, | 0, | 0; | | | |
| MotorPowerConstraint | Boolean Cmd, Power ActivePower | | | | | | |
| | T, | 1 | | | | | |
| | F, | 0 | | | | | |
| PumpSpeedCostraint | Power ActivePower, Sign ω | | | | | | |
| | 1, | + | | | | | |
| | 0, | 0 | | | | | |
| PumpTemperatureConstraint | Sign ω, Sign T_toTank, Sign T_fromPump | | | | | | |
| | +, | +, | + | | | | |
| | +, | −, | − | | | | |
| | 0, | *, | 0 | | | | |
| PumpPressureConstraint | Sign ω, Sign P_toTank, Sign P_fromPump | | | | | | |
| | +, | +, | + | | | | |
| | +, | −, | − | | | | |
| | 0, | *, | 0 | | | | |
| PumpFlowrateConstraint | Sign ω, Sign Q_toTank, Sign Q_fromPump | | | | | | |
| | +, | +, | + | | | | |
| | +, | −, | − | | | | |
| | 0, | *, | 0 | | | | |
| PumpECUCommandConstraint | String GTCommand, Boolean Cmd1, Boolean Cmd2, Boolean | | | | | | |
| | Cmd3 | | | | | | |
| | Startup, | T, | F, | T | | | |
| | Operation, | T, | F, | F | | | |
| | Standstill, | T, | F, | F | | | |
| | Coastdown, | F, | F, | F | | | |
| | Stop, | F, | F, | F | | | |
| PumpECUBackupConstraint | Sign P_Sensor1, Boolean Cmd2, Boolean Cmd3 | | | | | | |
| | −, | T, | T | | | | |
| PumpECUEmergencyConstraint | Sign P_Sensor2, Boolean Cmd3 | | | | | | |
| | −, | T | | | | | |

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for performing a model-based failure analysis of a complex industrial system comprising of hardware and/or software components each represented by a context independent component model, CM, comprising interface terminals and a set of component behaviour modes, BM, including a normal mode, NM, and failure modes, FM, of the respective component stated as constraints on deviations, the method comprising the steps of:
(a) generating a system model, SM, of an investigated industrial system by loading component models, CM, of the components of said investigated industrial system from a component library, CL, and connecting the interface terminals of the loaded component models, CM, according to a structure of the investigated industrial system; and
(b) executing a constraint-based predictive algorithm on a reasoning engine to generate qualitative FMEA results for different operation scenarios, OS, of the investigated industrial system.

2. The method according to claim 1, wherein the constraint-based predicted algorithm iterates over a Cartesian product of predefined operation scenarios, OS, and failure modes, FM, of each component to determine, whether the failure propagation entails a local or a system level effect capturing a violation of a functionality of the investigated industrial system.

3. The method according to claim 1, wherein the interface terminals of a component model, CM, of a component are formed by channels to other components comprising interface variables exchanged with the other components of the investigated industrial system.

4. The method according to claim 1, wherein the component model, CM, of a component comprises state variables indicating a state of said component.

5. The method according to claim 1, wherein the component model, CM, of a component comprises a base model, BM, capturing a physical behaviour of said component.

6. The method according to claim 1, wherein the component model, CM, comprises deviation models, DM, capturing deviations of actual values of variables from reference values of the variables.

7. The method according to claim 1, wherein the component model, CM, comprises local effects indicating effects of component faults of said component on a functionality of the investigated industrial system.

8. The method according to claim 1, wherein the generated FMEA results are used to predict a failure impact of a failure on the functionality of the investigated industrial system.

9. The method according to claim 1, wherein the system model, SM, is generated by connecting the interface terminals of loaded component models, CM, by means of a model editor according to a predetermined topology of the investigated industrial system.

10. The method according to claim 1, wherein the constraint-based predictive algorithm is executed on said reasoning machine offline during design, maintenance and/or repair of the investigated industrial system and/or online during operation of the investigated industrial system.

11. The method according to claim 1, wherein at least one component fault of said investigated industrial system is considered in response to the generated FMEA results.

12. An apparatus for model-based failure analysis of a complex industrial system comprising hardware and/or software components each represented by a context independent component model, CM, comprising interface terminals and a set of component behaviour modes, BM, including a normal mode, NM, and failure modes, FM, of the respective component stated as constraints on deviations, said apparatus comprising:
(a) a generation unit adapted to generate a system model, SM, of an investigated industrial system by loading component models, CM, of the components of said investigated industrial system from a component library, CL, and connecting the interface terminals of the loaded component models, CM, according to a structure of the investigated industrial system; and
(b) a reasoning engine adapted to execute a constraint-based predictive algorithm to generate FMEA results for different operation scenarios, OS, of the investigated industrial system.

13. The apparatus according to claim 12, further comprising a database adapted to store the component library, CL, comprising component models, CM, of components and adapted to store the system model, SM, of the investigated industrial system generated by said generation unit.

14. The apparatus according to claim 12, further comprising a control unit formed by a software component adapted to control at least one component of the investigated industrial system in response to the generated FMEA results.

15. An industrial system comprising hardware and/or software components and an apparatus according to claim 12.
